(19) United States
(12) Patent Application Publication
(10) Pub. No.: US 2008/0310809 A1
(43) Pub. Date: Dec. 18, 2008

(54) Optical film

(76) Inventors: Chin-Hui Chen, Yangmei Taoyuan (TW); Chun-Hao Huang, Yangmei Taoyuan (TW); Ming-Chuan Chen, Yangmei Taoyuan (TW); Chih-Chieh Kang, Yangmei Taoyuan (TW); Ping-Chun Yang, Yangmei Taoyuan (TW)

Correspondence Address: TROXELL LAW OFFICE PLLC;SUITE 1404, 5205 LEESBURG PIKE, FALLS CHURCH, VA, 22041, US

(21) Appl. No.: 11/896,737

(22) Filed: Sep. 5, 2007

(30) Foreign Application Priority Data
Jun. 14, 2007 (TW) 096121571

(51) Int. Cl. G02B 6/10

(52) U.S. Cl. 385/130

(57) ABSTRACT

An optical film including brightness enhancing, diffusion, and splitting layers; multiple optical microstructures being disposed on an upper surface of the brightness enhancing layer; the diffusion layer containing multiple diffusion grains; streams of light upon entering into the optical film delivering diffusion effect through the diffusion layer and provided with different traveling routes through the beam splitting layer to upgrade operation efficiency, create brightness enhancing effect through the brightness enhancing layer, and meet compact design requirements when applied in a backlight unit.

### BACKGROUND OF THE INVENTION

(a) Field of the Invention

The present invention is related to a construction of optical film, and more particularly, to one that is applied in a backlight unit to concentrate brightness enhancement, diffusion, and beams splitting functions on a single sheet of optical film for meeting compact requirements by minimizing use of other optical films, for upgrading operation efficiency of the light source in general, and effectively solving the problem of dim and dark regions as found with a backlight unit of the prior art.

(b) Description of the Prior Art

A configuration of direct or side emitting backlight unit may be selected for a liquid crystal display (LCD) generally applied in an information device according to design requirements. As illustrated in FIG. 1 of the accompanying drawings for a schematic view of a basic construction of a direct type backlight unit, a backlight unit 1 is comprised of a reflective frame 11, multiple light sources 12, a diffuser 13, multiple optical films 14, and a liquid crystal panel 15 disposed in sequence from the inside to the outside. Each light source 12 may be related to a tube made in a straight, U-shaped or other contentiously folded form with all light sources arranged at a proper gap at where between the frame 11 and the diffuser 13. Usually those multiple optical films 14 disposed at where between the diffuser 13 and the liquid crystal panel 15 are comprised of one up to three diffusers, none up to two BEFs, and none or one reflective polarizer to diffuse streams of light passing through those optical films for correcting dim and dark regions created on the liquid crystal unit due to absence of streams of light from gaps between two abutted light sources 12.

Whereas the only purpose of the diffuser 13 is to cause streams of light passing through it to diffuse uniformly, the results of correcting the dim and dark regions on the liquid crystal unit is very limited. In certain configuration, the gap between the light source 12 and the diffuser 13 is extended on purpose in the hope to expand the range for each light source 12 to enter into the diffuser 13 thus to achieve the purpose of minimizing the dim and dark regions. However, the result if any is also very limited, and the thickened backlight unit due to extended gap contradicts the compact requirements of the initial design.

As illustrated, multiple optical films 14 including a diffuser 141, a BEF 142, and a reflective polarizer 143 are disposed at where between the diffuser 13 and the liquid crystal panel 15 to improve the performance of luminance and brightness of the backlight unit 1 in general; however, complicated assembly process is required to repeat mounting those three optical films since each of them is an independent member, resulting in higher assembly cost and longer work hours. Furthermore, those three optical films must go through three rounds of cutting; and both of cutting cost and work hours are increased accordingly.

### SUMMARY OF THE INVENTION

The primary purpose of the present invention is to provide an optical film that provides three functions in one, respectively, brightness enhancing, diffusion, and beams splitting so that when the optical film is applied in a backlight unit, it minimizes use of extra optical films, upgrades operation efficiency of light sources of the backlight unit in general, effectively solve the problem of creating significant dim and dark regions by an optical film mounted in a backlight unit of the prior art, and realizes the purpose of a compact backlight module.

To achieve the purpose, an optical film of the present invention includes a brightness enhancing layer, a diffusion layer, and a beam splitting layer; multiple optical microstructures are disposed on an upper surface of the brightness enhancing layer; and the diffusion layer contains multiple diffusion grains. Upon entering into the optical film, streams of light are refracted to create diffusion effect through the diffusion layer and travel in different advancing routes through the beam splitting layer (e.g., different routes are created through penetration and reflection) in upgrading effective operation efficiency and distribution of streams of light emitted from light sources while producing brightness enhancing effect when streams of light pass through the brightness enhancing layer.

### BRIEF DESCRIPTION OF THE DRAWINGS

FIG. 1 is a schematic view showing a construction of a backlight unit of the prior art.

FIG. 2 is a schematic view showing a construction of a first preferred embodiment of an optical film of the present invention.

FIGS. 3(A), 3(B), 3(C), and 3(D) are perspective views showing constructions of different optical microstructures respectively contained in a beam splitting of the present invention.

FIG. 4 is a perspective view showing the optical film of the present invention is applied in a direct type backlight unit.

FIG. 5 is a schematic view showing advancing of streams of light in the direct type backlight unit as illustrated in FIG. 4.

FIG. 6 is a schematic view showing another construction of the optical film of the present invention is applied in a direct type backlight unit.

FIG. 7 is a schematic view showing a construction of the optical film of the present invention is applied in a side emitting backlight unit.

FIG. 8 is a schematic view showing another construction of the optical film of the present invention is applied in a side emitting backlight unit.

FIG. 9 is a schematic view showing another construction of the optical film of the present invention.

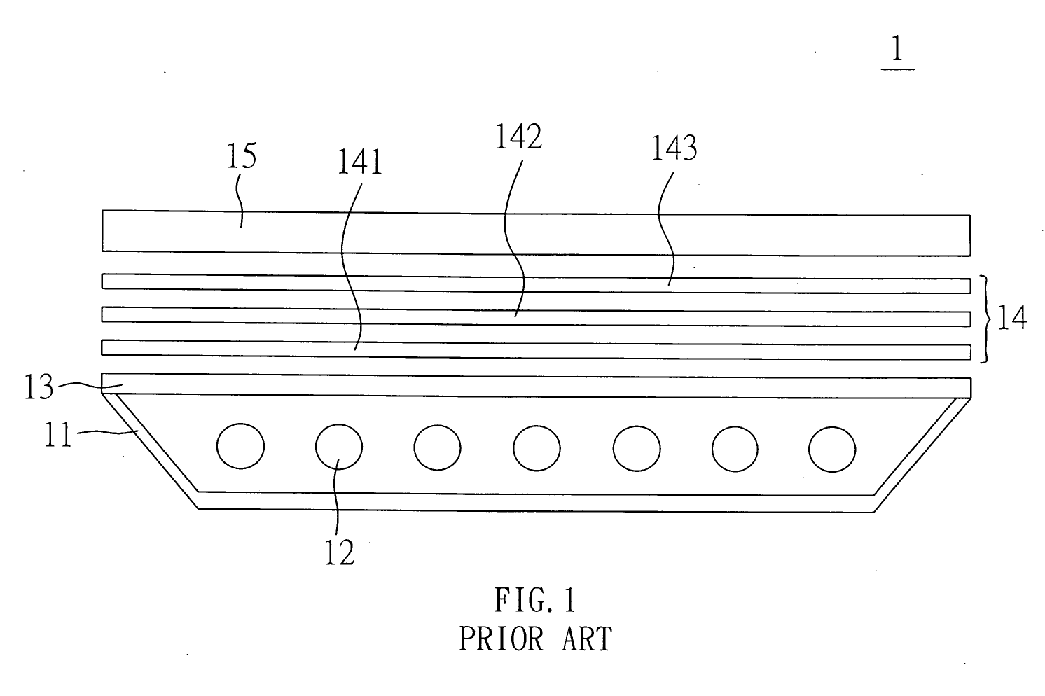

### DETAILED DESCRIPTION OF THE PREFERRED EMBODIMENTS

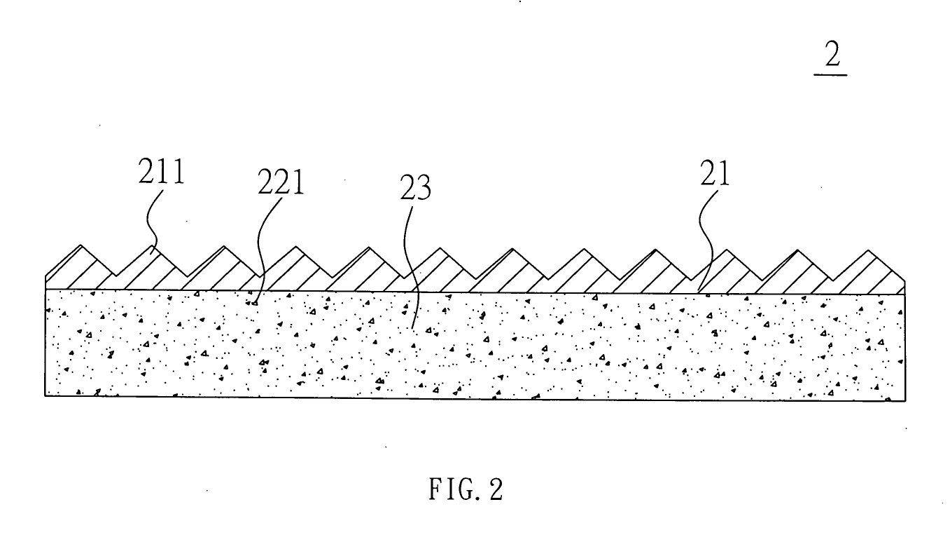

Referring to FIG. 2, a preferred embodiment of the present invention-an optical film 2 is essentially comprised of a brightness enhancing layer 21, a diffusion layer 22, and a beam splitting layer 23.

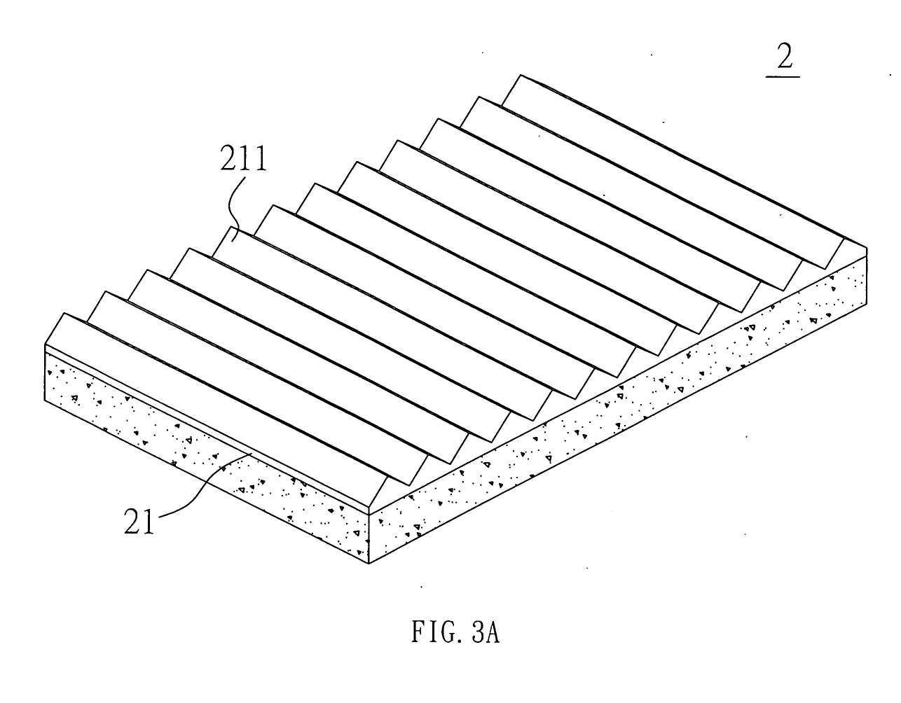

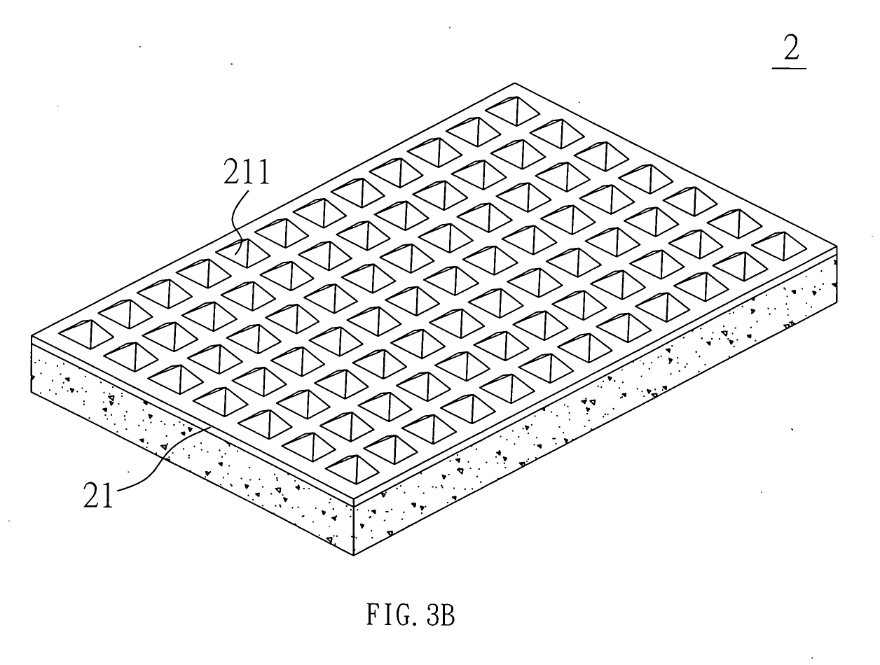

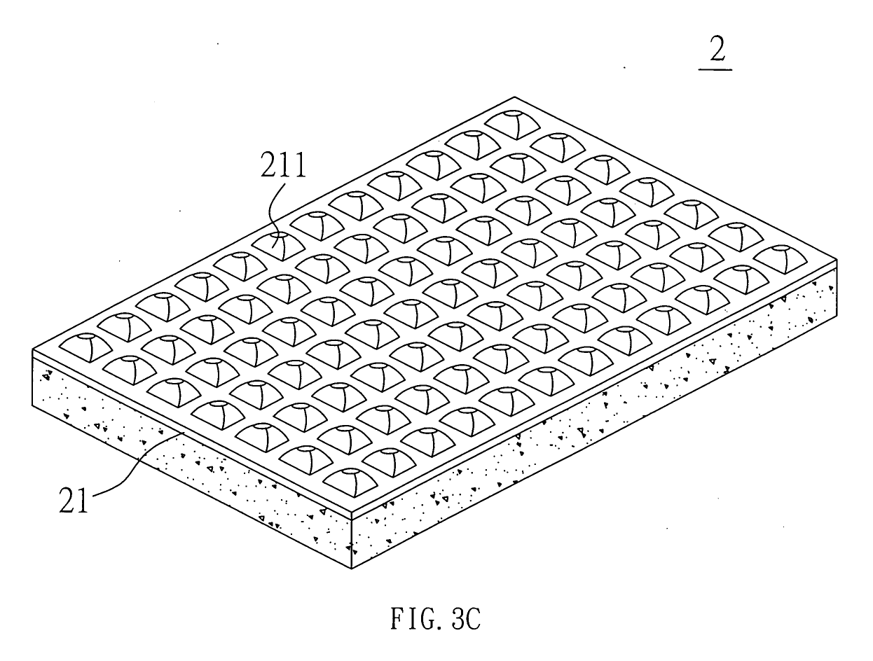

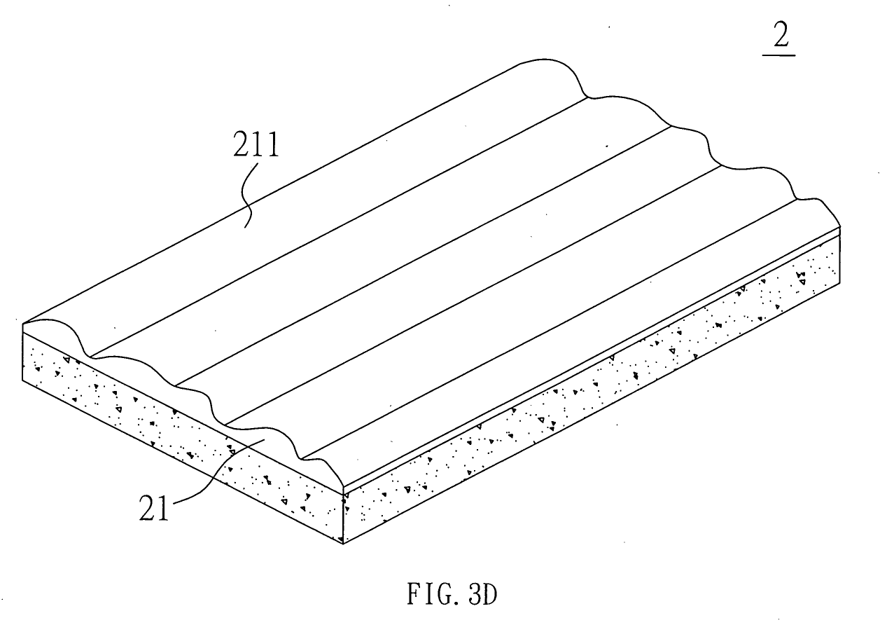

The brightness enhancing layer 21 is related to a transparent structure with its upper surface disposed with multiple optical microstructures 211; as illustrated, the optical microstructure 211 is related to a prism structure or any geometric structure that enhances brightness as illustrated in FIGS. 3(A), 3(B), 3(C), and 3(D) to deliver brightness enhancing effect; and each optical microstructure is molded on the brightness enhancing layer by means of lamination or rolling.

The diffusion layer 22 disposed on a lower surface of the brightness enhancing layer 21 contains multiple diffusion grains 221 or multiple diffusion grains each containing acrylic grains or multiple diffusion grains and multiple acrylic grains.

The beam splitting layer 23 disposed on a lower surface of the diffusion layer 22 is related to an optical structure that reflects or permits penetration by streams of light and contains a pretreated transparency or compound material to create different reflection and penetration routes for traveling by streams of light. The pretreatment process includes sandblasting, etching, atomizing, disposed with dots or polymer compound material. The beam splitting layer 23 may be pretreated to allow control of reflection rate and penetration rate and further allow adjustment of a ratio between the reflection rate and the penetration rate as desired.

Whereas the optical film 2 produced by combination of the brightness enhancing layer 21, the diffusion layer 22, and the beam splitting layer 23 using a process of coating, evaporating or sputtering provides brightness enhancing, diffusion, and beam splitting effects, it is capable of minimizing the use of diffuser, BEF, and reflective polarizer in a multi-layer optical film of the prior art to effective reduce assembly cost while upgrading brightness quality of the backlight unit.

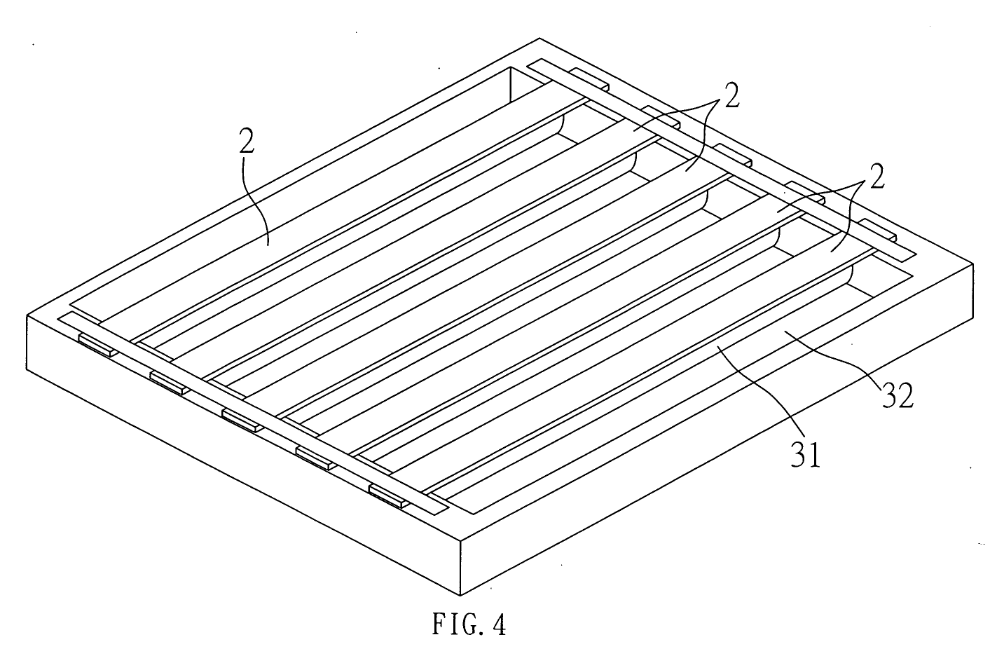

Now referring to FIG. 4 showing the optical film of the present invention applied in a backlight unit, the backlight unit contains multiple light sources 31; multiple optical films 2 are disposed over each light source 31 in relation to a traveling route of streams of light emitted from the light source 31; and a reflective film 32 is disposed below each light source 31 to constitute a direct type backlight unit.

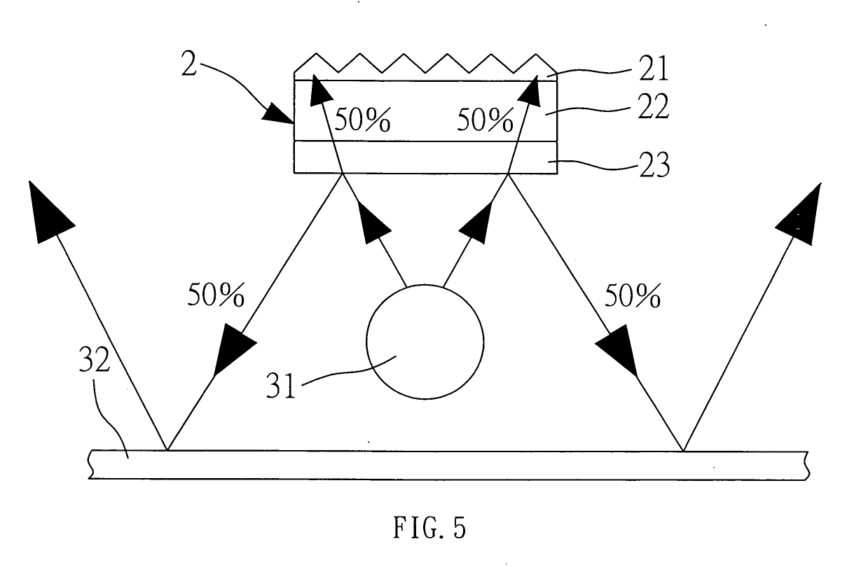

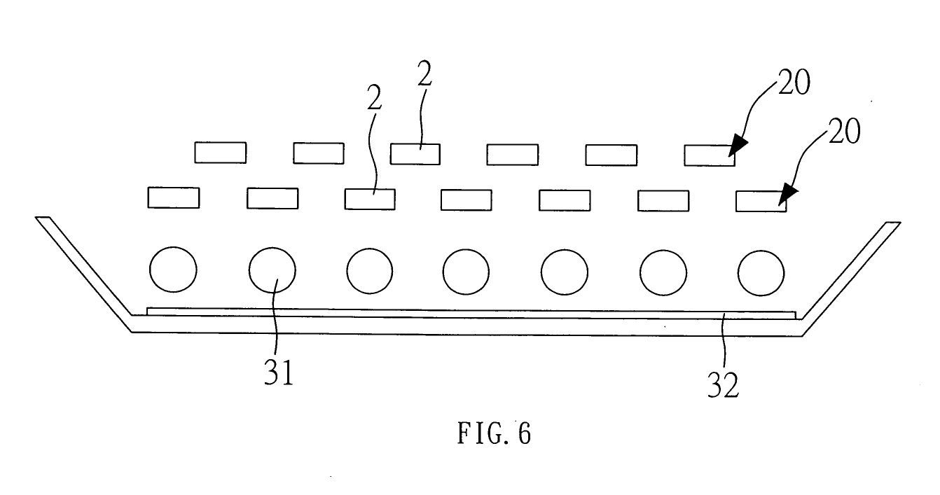

Traveling routes of streams of light emitted from each light source are illustrated in FIG. 5 with both of a reflection rate and penetration rate being controlled at 50% by the beam splitting layer 23 of the optical film 2; accordingly, 50% streams of light upwardly emitted from each light source 31 after penetrating the optical film 2 enter into the diffusion layer 22 above while the remaining 50% streams of light are reflected to the reflective film 32 disposed below each light source 31 and upwardly irradiate from the reflective film 32 so to deliver uniform luminance among those light sources 31 to upgrade effective use efficiency and effectively distribute streams of light form light sources while effectively eliminating dim and dark regions among light sources. Furthermore, those 50% streams of light entering into the diffusion layer 22 are refracted to create diffusion effect through the diffusion layer 22 to provide brightness enhancing effect after having passed through the brightness enhancing layer 22. Accordingly, streams of light are uniformly diffused to develop streams of light in high uniformity for upgrading quality of brightness of the backlight unit. As illustrated in FIG. 5, another layer of optical film 20 comprised of multiple optical films 2 may be provided over each light source 31, wherein those multiple optical films in each layer of optical film are overlapped from one another or alternatively arranged.

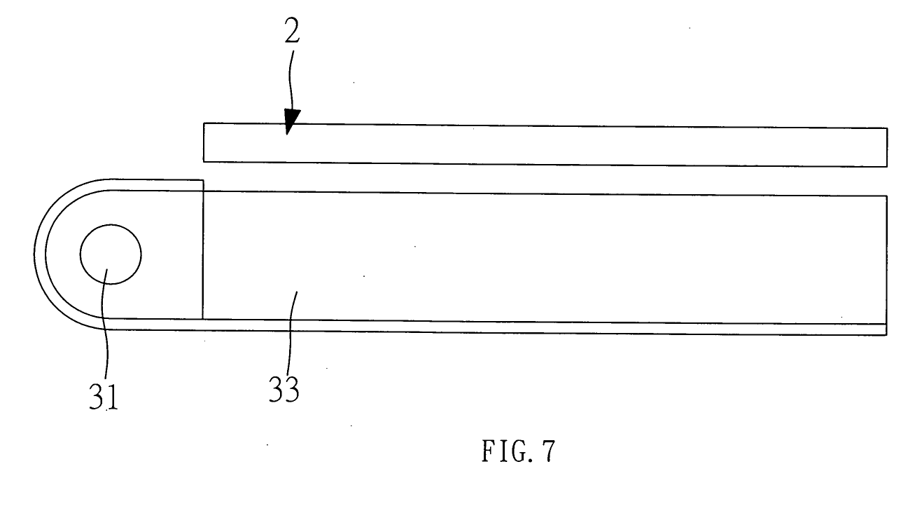

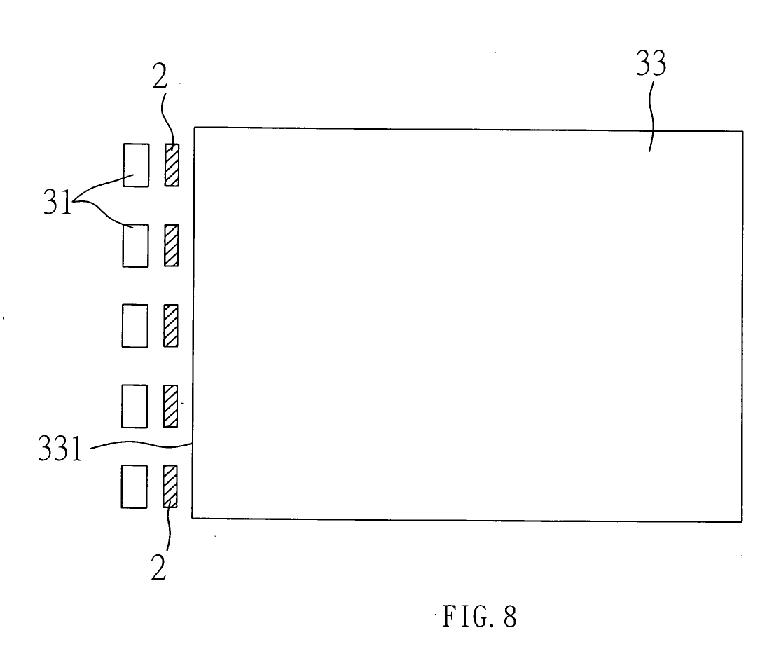

In another preferred embodiment of the present invention as illustrated in FIG. 7, a light guide plate 33 is disposed below the optical film 2 and an incident plane 331 is formed on a side edge (or both side edges) of the light guide plate 33 to constitute a side emitting backlight unit. The optical film 2 is disposed on the incident plane 331 of the light guide plate 33, and multiple light sources 31 are disposed to each optical film 2 on the other side opposite to the light guide plate 33 as illustrated in FIG. 8.

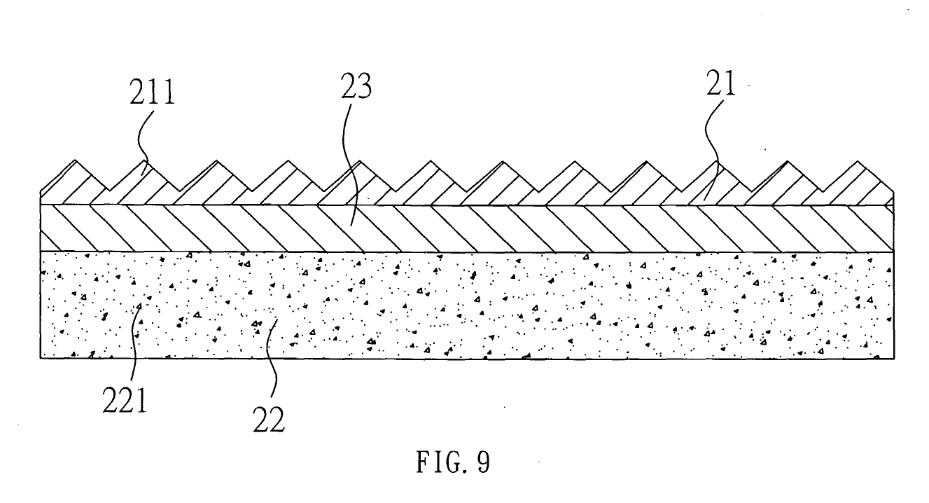

In another preferred embodiment yet of an optical film 2 of the present invention as illustrated in FIG. 9, the optical film 2 is comprised of the brightness enhancing layer 21, the beam splitting layer 23 disposed on the lower surface of the brightness enhancing layer 21, and the diffusion layer 22 disposed on the lower surface of the beam splitting layer 23 for the optical film 2 to deliver the same brightness enhancing, diffusion, and beam splitting effects. Therefore, application of the optical film 2 allows minimizing use of extra diffuser, BEF, and reflective polarizer in a conventional multi-layer optical film while effectively reducing assembly cost, upgrading quality of brightness of the backlight unit, and realizing the purpose of being compact.

The prevent invention provides a structure of an optical film, and the application for a patent is duly filed accordingly. However, it is to be noted that the preferred embodiments disclosed in the specification and the accompanying drawings are not limiting the present invention; and that any construction, installation, or characteristics that is same or similar to that of the present invention should fall within the scope of the purposes and claims of the present invention.

I claim:

1. A optical film comprising:
a brightness enhancing layer disposed on its upper surface multiple optical microstructures;
a diffusion layer containing multiple diffusion grains; and
a beam splitting layer to provide different traveling routes for streams of light;
wherein the diffusion layer being alternatively disposed on a lower surface of the brightness enhancing layer; the beam splitting layer being disposed on a lower surface of the diffusion layer; or the beam splitting layer being disposed on the lower surface of the diffusion layer; and the diffusion layer being disposed on a lower surface of the beam splitting layer.

2. The optical film as claimed in claim 1, wherein the optical microstructure is related to a prism or any geometric pattern that delivers brightness enhancing effect to provide brightness enhancing effect.

3. The optical film as claimed in claim 1, wherein the diffusion layer contains multiple diffusion grains with each containing multiple acrylic grains.

4. The optical film as claimed in claim 1, wherein the beam splitting layer is related to an optical structure that permits light reflection and permeation; and is comprised of a pretreated transparency or compound material

5. The optical film as claimed in claim 4, wherein the process used for the pretreatment is related to sandblasting, etching, atomizing, disposed with dots or polymer compound material.

6. The optical film as claimed in claim 1, wherein the diffusion layer contains multiple diffusion grains and multiple acrylic grains.

7. The optical film as claimed in claim 1, wherein the brightness enhancing layer is related to a transparent structure.

8. The optical film as claimed in claim 1, wherein multiple light sources are disposed at where below the optical film.

9. The optical film as claimed in claim 8, wherein multiple optical films are disposed over each light source.

10. The optical film as claimed in claim 8, wherein an optical film layer comprised of multiple optical films are disposed over each light source; and those multiple optical films of the optical film layer are overlapped or alternatively arranged.

11. The optical film as claimed in claim 8, wherein a light guide plate is disposed at where below the optical film; and either side or both sides of the light guide plate is disposed with multiple light sources.

12. The optical film as claimed in claim 11, wherein the optical film is disposed on an incident plane of the light guide plate; and multiple light sources are disposed to the optical film on one side opposite to the light guide plate.

13. The optical film as claimed in claim 1, wherein the brightness enhancing layer, the diffusion layer, and the beam splitting layer are combined into the optical film by means of coating, evaporating, or spurting.
